(19) United States
(12) Patent Application Publication
(10) Pub. No.: US 2004/0191514 A1
(43) Pub. Date: Sep. 30, 2004

(54) Sizing formulation for phenolic pultrusion and method of forming same

(76) Inventors: Jeffrey L. Antle, Canyon, TX (US); Donald R. Holman, Amarillo, TX (US)

Correspondence Address: OWENS CORNING, 2790 COLUMBUS ROAD, GRANVILLE, OH, 43023, US

(21) Appl. No.: 10/789,206

(22) Filed: Feb. 27, 2004

Related U.S. Application Data
(60) Provisional application No. 60/458,209, filed on Mar. 27, 2003.

(51) Int. Cl. B32B 3/00

(52) U.S. Cl. 428/359

(57) ABSTRACT

A sizing formulation and method of making a sizing formulation for fiberglass reinforcement rovings used in phenolic pultrusion are provided. The sizing formulation includes 1-7% of a film forming polymer, 0.3-3.5% of a silane coupling agent, 0.5-3.0% of a nonionic lubricant, and 0.2-3.5% of a cationic lubricant. Optionally, the sizing composition contains up to 3% of a waterborne urethane solution. The sizing composition is highly compatible with phenolic resins used in pultrusion processes and promotes an improved interface and increased compatibility between the individual fibers and the matrix resin. This increased interface results in better mechanical properties so that a fiber reinforced phenolic resin composite part having superior performance characteristics can be formed.

### TECHNICAL FIELD AND INDUSTRIAL APPLICABILITY OF THE INVENTION

The present invention relates generally to sizing formulations, and more particularly, to sizing formulations for fiberglass reinforcement rovings which may be used in phenolic pultrusion. A method of making a sizing formulation compatible with phenolic pultrusion is also provided.

### BACKGROUND OF THE INVENTION

Reinforced composites are rapidly growing in popularity for such applications as automobile components, boat hulls, and fishing rods. Reinforced polymeric composites can be formed from a polymeric matrix material, reinforcing material, or any other desired components in a variety of ways. Such composites are formed using glass fiber reinforcements which provide dimensional stability and excellent mechanical properties to the resulting composites. For example, glass fibers provide dimensional stability as they do not shrink or stretch in response to changes in atmospheric conditions. Further, glass fibers have high tensile strength, heat resistance, moisture resistance, and high thermal conductivity.

Glass fibers are commonly manufactured by supplying glass in molten form to a bushing, drawing fibers from the bushing, and then gathering the fibers into a tow or strand. A sizing composition, or chemical treatment, is typically applied to the fibers after they are drawn from the bushing. The sizing composition may protect the fibers from breakage during subsequent processing. Typical sizing compositions may include coupling agents, film formers, lubricants, emulsifiers, or antistatic agents that are dissolved or dispersed (in the form of an emulsion or dispersion) in water. However, some organic solvents conventionally used, such as styrene and xylene, are flammable and pose both a fire and a health hazard. Lithium chloride is also commonly used in sizing compositions as an antistatic agent, but tends to adversely affect yield, and is therefore undesirable for use.

A sizing composition is desirable if the glass is to be used as a reinforcement for a polymeric material. The sized strands are typically wound onto a collet, packaged, dried, and then wound together into a continuous roving. Several difficulties have been associated with the use of continuous fibers and the rovings made from these fibers. One problem with the use of wound rovings is the breakage of the individual fibers during winding, unwinding, or handling of the strands. Inter-filament abrasion of the fibers causes them to break, and, as a result, loose ends are separated from the fiber strands. These loose, broken ends form a roughened layer or fuzz on the surface of the fibers. Fuzz may also develop when fibers break during the weaving process. This fuzz is undesirable because it affects the appearance of the woven product. Breakage of the fibers also results in a build-up of fuzz on the contact points and other surfaces of the processing machinery. This fuzz buildup in turn is exacerbated by static electricity. In addition, the fuzz often becomes airborne, and thus becomes a source of skin and respiratory irritation to some workers handling the fiber strands. Further, the fuzz may collect to form tufts or balls of broken fibers, which then jam the processing equipment or fall into the resin baths used for dipping the fiber strands.

Another problem related to the use of sizing compositions is incompatibility between the sizing composition and the polymer matrix used to form the composites. Several ways to solve the problem of incompatibility between the fibers and the polymer composite material into which they are implanted have been attempted, including the development of compositions containing curing or coupling agents. However, there remains a recognized need for an agent that facilitates intimate bonding between the glass fibers and the polymer matrix.

Accordingly, a need exists in the art for an improved sizing composition which is easy to manufacture and apply to fibers, protects the glass fibers from abrading, improves the chemical interface between the resin and the glass, and does not use include environmentally undesirable components.

### SUMMARY OF THE INVENTION

At least one exemplary embodiment of the present invention provides a sizing formulation that includes 1-7% of a film forming polymer, 0.3-3.5% of a silane coupling agent, 0.5-3.0% of a nonionic lubricant, and 0.2-3.5% of a cationic lubricant. Optionally, the sizing formulation may include 0-3% of a water dispersible aliphatic polyether based polyurethane solution. The film forming polymer component of the sizing composition may include any polymer identified by those of skill in the art to form a thin film on glass fibers. However, suitable examples of film forming polymers for use in the sizing formulation include resins such as acrylics, polyamides, polyester, polyvinyl acetate, polyurethanes, and phenolics. Cationic lubricants which can be used in the sizing composition include partially amidated long chain polyalkylene imines. Preferably, the partially amidated polyalkylene imine adduct is a condensation reaction product of polyethylene imine with a fatty acid such as pelargonic and caprylic acids. The nonionic lubricant may be a polyoxyalkylated polyalkylene glycol ester, such as a fatty acid monoester. Preferably, the nonionic lubricant is polyethylene glycol mono-oleate. Coupling agents typically used in the sizing formulation include organosilanes such as gamma-aminopropyltriethoxy silane, N-beta (aminoethyl) gamma-aminopropyltrimethoxy silane, vinyltrimethoxy silane, gamma-glycidoxypropyltrimethoxy silane, aminofunctional silane esters, and phenylaminopropyltrimethoxy silane.

In another exemplary embodiment of the present invention, a method for forming a sizing formulation that includes 1-7% of a film forming polymer, 0.3-3.5% of a silane coupling agent, 0.5-3.0% of a nonionic lubricant, and 0.2-3.5% of a cationic lubricant is provided. In particular, each of the ingredients of the sizing formulation are separately pre-mixed in water maintained at a temperature of from approximately 70-80° F. Preferably, the water is demineralized water. The pre-mixes are agitated to provide a homogeneous mixture, and then added to a main mixing tank. The resulting composition is then agitated in the main mixing tank for a period of time, usually 5-10 minutes. The composition may be tested for solids content by driving off the water and any volatile material to yield only the solids (e.g., organic solids) present in the mix using heat (e.g., 110° F. for 60 minutes). Demineralized water may then be added to attain a desired ratio of solids (e.g., 3-6% solids).

### DETAILED DESCRIPTION AND PREFERRED EMBODIMENTS OF THE INVENTION

Glass fibers used as reinforcing elements are usually coated with a size coating which serves to protect the fibers from damage by abrasion during processing, handling and/or use, to bind the individual fibers into more-or-less tightly integrated multi-fiber bundles or strands, and/or to enhance the reinforcing interaction between the fibers and the resinous matrix in which they are imbedded as reinforcing elements. Glass fibers are typically formed by flowing molten glass through a plurality of suitable orifices (e.g., bushings) so as to attenuate these streams to the desired fiber diameter as they cool and solidify.

Once the glass fibers are formed, a sizing composition is applied. Liquid sizing compositions can be applied by spraying, by drawing the fibers across a suitable roll, belt, apron, pad, etc. wet with the liquid sizing composition, or other conventional liquid coating methods known to those of skill in the art. The sizing composition may be applied to the glass fibers in-line during the formation of the glass fibers immediately after the fiber is formed. Application of the sizing composition in-line helps to protect the fibers from damage during the remainder of the forming process and subsequent handling of the glass fibers. Alternatively, glass fibers that were previously formed and/or packaged may be coated with a sizing formulation off-line. The size coating on the glass fibers reduces the occurrence of broken filaments (fuzz) and improves processing properties of the fibers such as fiber bundle cohesion, fiber smoothness and softness, abrasion resistance, and ease of unwinding the fiber bundles. The glass fibers may then be dried (e.g., in an oven) and collected into a suitable package for further processing, storage and/or shipment, such as by winding onto a continuous roving. The roving may then be used in a subsequent process, such as a pultrusion process, to form a reinforced composite part.

In a phenolic pultrusion process, a reinforced composite is formed when a thermosetting polymer is forced between the fibers of a glass roving as it is pulled through a resin bath coating apparatus, profiling, and alignment dies. For example, glass rovings are fed into a phenolic resin bath where they are moved over spreader bars which aid in impregnating the resin into the glass fibers. Once these rovings are sufficiently impregnated with the resin, they exit the resin bath. These impregnated rovings are pre-formed into a shape or profile (e.g., a rod) prior to entering a molding die. The rovings which have the pre-formed shape are then cured into the form of the composite by heating continuously as the part passes through the heated die. The composite part exiting the heated die is then cut to a desired length. In this manner, the continuous roving is impregnated with a polymer resin, and the resin and fibers are shaped into the form of the composite.

Sizing compositions for coating fibers used in such a phenolic pultrusion process according to embodiments of the present invention includes 1-7% of a film forming polymer, 0.3-3.5% of a silane coupling agent, 0.5-3.0% of a nonionic lubricant, and 0.2-3.5% of a cationic lubricant. Optionally, the sizing formulation includes 0-3% of a water dispersible aliphatic polyether based polyurethane solution.

The film forming polymer component of the sizing composition may include any polymer identified by those of skill in the art to form a thin film on glass fibers. Suitable examples of film forming polymers for use in the sizing formulation include resins such as acrylics, polyamides, polyester, polyvinyl acetate, polyurethanes, and phenolics. In a preferred embodiment, the film forming polymer is a polyamide, such as is commercially available from Georgia Pacific Resins, Inc., and is identified as GP 2925 (Glass and Mineral Fiber Sizing Agent).

Cationic lubricants which can be used in the sizing composition include partially amidated long chain polyalkylene imines. The partially amidated polyalkylene imines typically have a residual amine value from about 200 to about 800 and are reactive products of a mixture of about C₂ to about C₁₈ fatty acids with a polyethylene imine having a molecular weight from about 800 to about 50,000. Amines suitable for forming the fatty acid salt of this reaction product include tertiary amines having a low molecular weight, such as, for example, where the alkyl groups attached to the nitrogen atom (amine) have from about 1 to 6 carbons. Preferably, the fatty acid moiety of the salt includes from about 8 to 22 carbon atoms. Most preferably, the partially amidated polyalkylene imine adduct is a condensation reaction product of polyethylene imine with a fatty acid such as pelargonic and caprylic acids. One example of such a condensation reaction product is commercially available from Cognis, Inc., and is identified as Emery 6760L. Alternatively, the partially amidated polyalkylene imine adduct is the reaction product of tetraethylene pentamine reacted with pelargonic acid, tetraethylene pentamine reacted with stearic acid, or tetraethylene pentamine reacted with caprylic acid.

The nonionic lubricant can be a polyoxyalkylated polyalkylene glycol ester, such as a fatty acid monoester. Preferably, the nonionic lubricant is an alkoxylated polyethylene glycol fatty acid ester such as polyethylene glycol mono-oleate. In a preferred embodiment, the nonionic lubricant is a mono-oleate ester including polyethylene glycol groups having an average molecular weight of about 400. One such particular mono-oleate ester that can be used is marketed commercially as PEG 400 MO by Ethox, Inc.

The coupling agents typically used in the sizing formulation have hydrolyzable groups that are capable of reacting with a glass surface to remove unwanted hydroxyl groups. For example, the coupling agent can have 1-3 hydrolyzable functional groups which can interact with the surface of the glass fibers, and one or more organic groups that are compatible with the polymer matrix. Preferred coupling agents include organosilanes such as gamma-aminopropyltriethoxy silane, N-beta (aminoethyl) gamma-aminopropyltrimethoxy silane, vinyltrimethoxy silane, gamma-glycidoxypropyltrimethoxy silane, aminofunctional silane esters, and phenylaminopropyltrimethoxy silane. A particularly suitable silane for this invention is the gamma-aminopropyltriethoxy silane, A-1100, which is commercially available from CK Witco Corporation.

Optionally, the sizing formulation may also include a water dispersible aliphatic polyether based polyurethane solution that is solvent-free, non-hazardous, and free of pollutants. One example of a suitable water dispersible polyether based polyurethane solution is Hydrosize™ U6-X03 from Hydrosize™ Technologies Inc., Raleigh, N.C.

To formulate such a sizing composition, each of the ingredients maybe separately pre-mixed in water maintained at a temperature of from approximately 70-80° F. Preferably the water is demineralized water. The amount of water used for each respective pre-mix varies depending on the ease of dispersion and solubility of the particular ingredient. The pre-mixes can then be agitated and added to a main mixing tank. The resulting composition is then agitated in the main mixing tank for a period of time suitable to provide a homogenous solution, usually 5-10 minutes. Optionally, the composition can be tested for solids content by driving off the water and any volatile material to yield the solids (e.g, organic solids) present in the mix using heat (e.g., 110° F. for 60 minutes). Optionally, demineralized water may be added to attain a desired ratio of solids, e.g., 3-6% solids. The targeted mix solids provides the correct final strand solids.

Representative examples of sizing formulations according to the invention are set forth in Tables 1-5 below.

TABLE 1

| | | Preferred | Range of | | |
|---|---|---|---|---|---|
| | % | % by | % by | Preferred | Range of |
| | Active | weight | weight | % | % |
| | Solids | as | as | of dried | of dried |
| Material | (a) | received | received | coating | coating |
| GP 2925 | 21.5 | 3.27 | 1.0-7.0 | 17.2% | 5-30% |
| A-1100 | 58 | 0.72 | 0.3-3.5 | 10.2% | 5-50% |
| Acetic Acid | 100 | 0.23 | 0.10-0.5 | 0% | 0.000 |
| PEG 400 MO | 100 | 2.76 | 0.5-3.0 | 67.5% | 20-70% |
| Emery 6760L | 12.5 | 1.68 | 0.2-3.5 | 5.1% | 1-10% |
| D.M. Water | 0 | 89.72 | remainder | 0% | 0% |

(a) Percentage weight solids used to calculate the predicted size mix solids.

TABLE 2

| | % Active | lbs./100 |
|---|---|---|
| MATERIAL | Solids | Gallons |
| GP 2925 | 21.5 | 27.20 |
| A-1100 | 58 | 6.00 |
| Acetic Acid | 100 | 1.93 |
| PEG 400 MO | 100 | 23.00 |
| Emery 6760L | 12.5 | 14.00 |
| D.M. WATER | 0 | 760.87 |
| Calc. Mix | 4.09 | 833 |
| Solids | | |

TABLE 3

| | % Active | lbs./100 |
|---|---|---|
| MATERIAL | Solids | Gallons |
| Hydrosize ™ U6-X03¹ | 30 | 12.55 |
| GP 2925 | 21.5 | 17.51 |
| A-1100 | 58 | 12.00 |
| Acetic Acid | 100 | 3.86 |
| Emery 6760L | 12.5 | 14.00 |
| PEG 400 MO | 100 | 22.00 |
| D.M. WATER | 0 | 751.08 |
| Calc. Mix | 4.59 | 833 |
| Solids | | |

¹Hydrosize ™ U6-X03 is a water dispersible aliphatic polyether based polyurethane solution.

TABLE 4

| | % Active | lbs./100 |
|---|---|---|
| MATERIAL | Solids | Gallons |
| A-1126¹ | 33.7 | 41.70 |
| Acetic Acid | 100 | 10.10 |
| EE-732² | 33 | 30.30 |
| PEG 400 MO | 100 | 13.80 |
| D.M. WATER | 0 | 742.9 |
| Calc. Mix | 4.54 | 833 |
| Solids | | |

¹A-1126 is an amino functional silane ester.
²EE732 is a modified epoxy film former.

TABLE 5

| | % Active | lbs./100 |
|---|---|---|
| MATERIAL | Solids | Gallons |
| Hydrosize ™ U6-X03¹ | 30 | 12.8 |
| PD-166² | 53 | 3.55 |
| A-1100 | 58 | 25.97 |
| Acetic Acid | 100 | 8.35 |
| Emery 6760L | 12.5 | 4.60 |
| PEG 400 THE MOCHIDUKI | 100 | 17.00 |
| '973 PATENT | | |
| D.M. WATER | 0 | 760.73 |
| Calc. Mix | 4.60 | 833 |
| Solids | | |

¹Hydrosize ™ U6-X03 is a water dispersible aliphatic polyether based polyurethane solution.
²PD-166 is an epoxy modified polyvinyl acetate copolymer.

When the sizing composition is applied to glass fibers, a roving is formed that is compatible with a phenolic resin bath used in a pultrusion process. The sizing composition is highly compatible with the phenolic resin so that the individual glass fibers are sufficiently dispersed or wetted by the matrix resin. This promotes better fiber strand defilamentization, or strand breakup, which reduces fiber prominence and improves the uniformity or smooth appearance of the surface of the resulting composite and promotes an increased interface between the individual fibers and the matrix resin. This increased interface results in better mechanical properties, which are needed in structural applications. As a result, a fiber reinforced phenolic resin composite part having superior performance characteristics can be formed.

In addition, the sizing composition minimizes fuzz or broken filaments in the processing of the roving into the finished composite part, yet breaks up during the resin wetout process to give excellent resin impregnation. Further, improved compatibility can also provide for increased line speeds to improve productivity. The improved compatibility may allow a faster cure rate which gives the manufacturer the opportunity to produce more material with the same equipment.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A sizing composition compatible with a phenolic pultrusion process comprising:
1-7% of a film forming polymer;
0.5-3.0% of a silane coupling agent;
0.5-3.0% of a non-ionic lubricant;
0.2-3.5% of a cationic lubricant; and
0-3% of a water dispersible polyether based polyurethane solution.

2. The sizing composition of claim 1, wherein the film forming polymer is selected from the group consisting of acrylics, polyamides, polyesters, polyvinyl acetate, polyurethanes and phenolics.

3. The sizing composition of claim 1, wherein the non-ionic lubricant is a polyoxyalkylated polyalkylene glycol ester.

4. The sizing composition of claim 3, wherein the non-ionic lubricant is polyethylene glycol mono-oleate.

5. The sizing composition of claim 1, wherein the silane coupling agent is an organosilane.

6. The sizing composition of claim 5, wherein the silane coupling agent is selected from the group consisting of gamma-aminopropyltriethoxy silane, N-beta (aminoethyl) gamma-aminopropyltrimethoxy silane, vinyltrimethoxy silane, gamma-glycidoxypropyltrimethoxy silane and phenylaminopropyltrimethoxy silane.

7. The sizing composition of claim 1, wherein the cationic lubricant is a partially amidated polyalkylene imine.

8. The sizing composition of claim 7, wherein the partially amidated polyalkylene imine is a condensation reaction product of olyethylene imine with a fatty acid selected from the group consisting of pelargonic acid and caprylic acid.

9. The sizing composition of claim 1, wherein the sizing composition provides an increased compatibility between individual glass fibers and a matrix resin in a phenolic pultrusion process.

10. The sizing composition of claim 1, wherein the film forming polymer is a polyamide, the silane coupling agent is an organosilane, the non-ionic lubricant is a polyoxyalkylated polyalkylene glycol ester, and the cationic lubricant is a partially amidated polyalkylene imine.

11. A method of making a sizing composition compatible with a phenolic pultrusion process comprising:
admixing 1-7% of a film forming polymer, 0.5-3.0% of a silane coupling agent, 0.5-3.0% of a non-ionic lubricant, 0.2-3.5% of a cationic lubricant, and 0-3% of a water dispersible polyether based polyurethane solution to form an admixture; and
agitating the admixture for a period of time sufficient to provide a homogenous composition.

12. The method of claim 11, wherein the film forming polymer is a polyamide, the silane coupling agent is an organosilane, the non-ionic lubricant is a polyoxyalkylated polyalkylene glycol ester, and the cationic lubricant is a partially amidated polyalkylene imine.

13. The method of claim 11, wherein the period of time sufficient to form an admixture is 5-10 minutes.

14. The method of claim 11, further comprising:
individually pre-mixing the film forming polymer, the silane coupling agent, the non-ionic lubricant, and the cationic lubricant in water to form a pre-mix of each of the film forming polymer, the silane coupling agent, the non-ionic lubricant, and the cationic lubricant.

15. The method of claim 14, wherein the pre-mix is maintained at a temperature of approximately 70-80° F.

16. The method of claim 14, wherein the water is demineralized water.

17. A fiber product comprising at least one glass fiber coated with a sizing composition according to claim 1.

18. A method of forming a sized glass fiber comprising:
applying a sizing composition compatible with a phenolic pultrusion process to at least one glass fiber, the sizing composition including:
1-7% of a film forming polymer;
0.5-3.0% of a silane coupling agent;
0.5-3.0% of a non-ionic lubricant;
0.2-3.5% of a cationic lubricant;
0-3% of a water dispersible polyether based polyurethane solution; and
drying the sizing composition onto the at least one fiber to form a sized glass fiber;
wherein the sizing composition provides an increased compatibility between individual glass fibers and a matrix resin in the phenolic pultrusion process.

19. The method of claim 18, wherein the film forming polymer is a polyamide, the silane coupling agent is an organosilane, the non-ionic lubricant is a polyoxyalkylated polyalkylene glycol ester, and the cationic lubricant is a partially amidated polyalkylene imine.

20. A dry sizing composition compatible with a phenolic pultrusion process comprising:
5-30% solids content of a film forming polymer;
5-50% solids content of a silane coupling agent;
20-70% solids content of a non-ionic lubricant;
1-10% solids content of a cationic lubricant; and
0-30% solids content of a water dispersible polyether based polyurethane solution.

21. The dry sizing composition of claim 20, wherein the film forming polymer is a polyamide, the silane coupling agent is an organosilane, the non-ionic lubricant is a polyoxyalkylated polyalkylene glycol ester, and the cationic lubricant is a partially amidated polyalkylene imine.
